(19) United States
(12) Patent Application Publication
(10) Pub. No.: US 2022/0032592 A1
(43) Pub. Date: Feb. 3, 2022

(54) FLEXIBLE MULTI-LAYERED FILM HAVING UV AND VISIBLE LIGHT BARRIER LAYER FOR MEDICAL PACKAGING

(71) Applicant: POLYCINE GMBH, Schiffweiler (DE)

(72) Inventors: Susanne HOLZER, Ottweiler (DE); Rene GROSS, Neunkirchen (DE)

(21) Appl. No.: 17/413,782

(22) PCT Filed: Dec. 17, 2019
(86) PCT No.: PCT/EP2019/085602

§ 371 Date: Jun. 14, 2021

(30) Foreign Application Priority Data
Dec. 17, 2018 (EP) 18213150.8

(51) Int. Cl. B32B 27/20; B32B 27/32; B32B 27/08; B32B 37/15

(52) U.S. Cl. CPC B32B 27/20; B32B 27/32; B32B 27/08; B32B 37/153; B32B 2250/242; B32B 2307/71; B32B 2439/80; B32B 2250/03; B32B 2307/732

(57) ABSTRACT

The invention relates to flexible multilayer films comprising a first polymer layer (A), a second polymer layer (B), and a central polymer layer (C), wherein the central polymer layer (C) is situated between the first polymer layer (A) and the second polymer layer (B), and wherein the central polymer layer (C) comprises at least one UV absorber and at least one colorant that, in combination, absorb light in the 175 nm to 525 nm wavelength range. The multilayer film is suitable for producing medical bags having UV and light protection.

The invention relates to heat-sterilizable multilayer films comprising aliphatic polyolefins, to a process for production thereof, and to the use thereof for the production of medical packagings, and also to medical packagings containing such multilayer films.

Multilayer films have been used in a broad field of application for many years, for example in the food industry but also in the medical/pharmaceutical sector, for example as secondary packaging material (outer packaging) or primary packaging material for solution bags, dry concentrates, and medicaments in tablet form.

Some multilayer films can be processed into flexible packagings that are suitable for example as bags for packaging and administering medical solutions. As current practice, medical solutions such as infusion solutions for parenteral administration are currently marketed in flexible disposable bags made of polyvinyl chloride (PVC) or non-PVC materials.

In addition to the ability to collapse, which ensures complete emptying of the bag, the bag must demonstrate other performance criteria such as transparency, ability to undergo heat sterilization at 121° C., adequate mechanical strength, particularly with dynamic loads in the weld seam area, good barrier to water vapor, load capacity for standard pressure-cuff applications, e.g. pressure infusions, and—from a pharmaceutical viewpoint—the smallest possible influence on the bag contents due to the packaging.

In accordance with the properties mentioned, it is advantageous to opt for a multilayer film having a polyolefin-based layer structure. Such multilayer films are described for example in DE 103 61 851 A1.

Certain medical products, such as for example vitamins, antiinfectives, cytostatics, cardiovascular medicaments, gastrointestinal therapeutics, psychotropic agents, and analgesics, are particularly sensitive to light and UV radiation. If such medicaments that need to be administered with protection from light are not stored and administered in the correct manner, active ingredient degradation and/or the formation of toxic by-products can occur, which can harm the health of the patient.

WO 01/53083 A1 describes a transparent, biaxially oriented, UV-stabilized, sealable film having a thickness within the range from 10 to 500 μm, which comprises a crystallizable thermoplastic as the principal component, characterized in that it additionally comprises at least one UV absorber soluble in the thermoplastic in a concentration of 0.01% to 5.0% by weight, said film being provided on one surface with a barrier layer to reduce permeability to gases and odors and furnished on the other surface with a heat-sealing lacquer or a heat-sealing layer. The UV absorber is selected from the group consisting of benzophenones, benzotriazoles, organic nickel compounds, salicylic esters, cinnamic ester derivatives, sterically hindered amines, and triazines.

WO 2009/013529 A1 describes a polypropylene film comprising at least two UV-absorbing additives. The first, inorganic, additive consists of mineral and/or metal oxides such as for example nano zinc oxide and/or nano titanium oxide (particle size <200 nm) and is present in a concentration of 0.1% to 5.5% by weight. The second, organic, additive, selected from the group of triazines, sterically hindered amines, oxanillines, cyanoacrylates, benzotriazoles, and benzophenones, is present in a concentration of less than 2%. The drawback of this film is inter alia that nanoscale inorganic additives are used, the use of which is controversial on account of possible adverse effects.

JP 2014024570 describes a medical, transparent packaging material consisting of a substrate layer, a gas barrier layer comprising silicon oxide (SiOx), an ultraviolet absorbing layer, and an adhesion-promoting layer (adhesion promoter for SiOx). The ultraviolet absorbing layer comprises a UV absorber and a fluorescent brightener. The UV absorber is a triazine. The fluorescent brightener is one or more substances from the group consisting of diaminostilbene derivatives, distyrylbiphenyl derivatives, and benzoxazolylthiophene derivatives. The medical packaging material is intended as a barrier outer packaging.

JP 2016033021 A discloses a container that blocks UV radiation in the 380 to 400 nm wavelength range and allows visible light to pass through. A triazine compound is used as the UV absorber here. JP 2016033021 A specifically concerns a UV barrier and not a light barrier; on the contrary, visible light must be able to penetrate the container unhindered.

EP 3000750 A1 describes light-screening multilayer films that screen out light in the wave range up to 400 nm and allow light in the wave range above this to pass through.

MX 2012014559 describes a polymer-based film having protection against UV that emits visible blue and green light by means of natural chromophores. The drawback of the described film in respect of light-sensitive medicaments is precisely that it is blue and green light being emitted, which is in the wavelength range that is damaging to light-sensitive medicaments.

KR 20170031419 A describes a film having a special barrier layer against water vapor and a UV barrier layer. The UV barrier is achieved by nanoscale UV pigments such as zinc oxide or titanium dioxide and covers a wavelength range of up to 380 nm.

CN 205185431 describes a medical packaging film consisting of an aluminum layer that is furnished on one side with an antibacterial nano-silver-containing layer and on the other side with a printable layer, a high-temperature-resistant polyurethane adhesive layer, and a multiple UV-screening glass coating that is in turn again provided with a protective layer. The drawback of this film is the complex structure, having an additionally required aluminum layer and a multiple glass coating that itself requires a protective layer. The production of the described medical film is accordingly complex, costly, and not very economical with resources.

Although good results have already been achieved with the known films, there is still plenty of room for improvement, particularly with regard to films suitable for the production of medical packagings that are intended to be used to hold light-sensitive substances.

The object was therefore to provide further, improved films for the production of medical packagings that are particularly suitable for holding solutions of light-sensitive substances and that at the same time have a high barrier to water vapor, this being particularly advantageous at low fill-volumes so as to minimize the loss of liquid from the packaging during storage.

The object is achieved by multilayer films based on aliphatic polyolefins, said films comprising in a central polymer layer (i.e. surrounded on either side by at least one further polymer layer) a combination of at least one UV absorber and at least one specialty colorant.

The invention accordingly provides a heat-sterilizable multilayer film comprising
a) a first polymer layer (A),
b) a second polymer layer (B), and
c) a central polymer layer (C),

wherein the central polymer layer (C) is situated between the first polymer layer (A) and the second polymer layer (B) and

wherein at least one, preferably each, of the three polymer layers (A), (B), and (C) comprises at least one aliphatic polyolefin,

characterized in that the central polymer layer (C) comprises at least one UV absorber and at least one colorant selected from the group consisting of organic pigments, inorganic pigments, organic dyes, and inorganic dyes,

wherein the combination of at least one UV absorber and at least one colorant absorbs radiation in the 175 nm to 525 nm wavelength range. Here, the first polymer layer (A) preferably comprises at least one polypropylene homopolymer.

The invention further provides a process for producing the multilayer film of the invention, comprising a step in which the first polymer layer (A), the central polymer layer (C), and the second polymer layer (B) are coextruded.

The invention additionally provides for the use of the multilayer film of the invention for producing a medical packaging.

The object of the invention is likewise achieved by a medical packaging produced from the multilayer film of the invention.

Also provided for by the invention is the use of the medical packaging of the invention as a container for at least one medicament.

The invention likewise provides a process for producing a medical packaging of the invention, comprising the steps of:
a) providing at least one multilayer film of the invention;
b) optionally providing one or more port elements and/or tubing units;
c) forming a packaging from the at least one multilayer film of the invention, such that the second polymer layer (B) forms the inner surface of the packaging and the first polymer layer (A) forms the outer surface of the packaging;
d) optionally positioning the port elements and/or tubing units between the inner surfaces at the edges of the packaging;
e) bringing the inner surfaces at the edges of the packaging into contact with one another and with port elements and/or tubing units optionally positioned therebetween; and
f) welding the inner surfaces at the edges of the packaging to one another and to port elements and/or tubing units optionally positioned therebetween.

The invention thus provides a polyolefin-based multilayer film that can be reliably welded and heat-sterilized in thermal welding processes with continuous heating, including in the presence of port elements, said films not requiring plasticizers, having minimal influence on medical solutions, and having a high barrier to water vapor. The polyolefin-based multilayer film is at the same time furnished with additional protection for light-sensitive medicaments against UV and light in the 175 nm to 525 nm range. Since UV absorbers cover only the ultraviolet range of the spectrum up to −380 nm, the film additionally comprises a color pigment for the visible range of the light spectrum up to −525 nm.

The combination of UV absorber and color pigment in the multilayer film of the invention preferably absorbs at least 40%, particularly preferably at least 60%, very particularly preferably at least 80%, of the light in the 175 nm to 525 nm range. The combination of UV absorber and color pigment is at the same time permeable preferably to at least 40%, particularly preferably to at least 60%, very particularly preferably to at least 80%, of the light in the range above 525 nm.

This means that there is no need for an aluminum coating/lamination, and the film remains transparent or translucent for visual assessment of the infusion solution.

In addition, no additional UV coating is required, which saves an additional work step and potentially an additional protective layer.

Moreover, the substances responsible for the UV and light protection are not released when the multilayer film or medical packaging of the invention comes into contact with a medicament, which means that contamination of the active substance is avoided, since these substances are present in the central polymer layer (C) that is surrounded by layers (A) and (B) and accordingly has no contact with the medicament.

In a preferred embodiment of the invention, all three polymer layers (A), (B), and (C) comprise one or more aliphatic polyolefins.

In another embodiment, polymer layers (A) and (B) each comprise one or more aliphatic polyolefins.

In another embodiment, polymer layers (A) and (C) each comprise one or more aliphatic polyolefins.

In another embodiment, polymer layers (B) and (C) each comprise one or more aliphatic polyolefins.

In another embodiment, only polymer layer (A) comprises one or more aliphatic polyolefins.

In another embodiment, only polymer layer (B) comprises one or more aliphatic polyolefins.

In another embodiment, only polymer layer (C) comprises one or more aliphatic polyolefins.

Preferred aliphatic polyolefins are polypropylene, polyethylene, polybutylene, and copolymers thereof, in particular bi- and terpolymers with aliphatic C₂-C₈ olefins.

The first polymer layer (A) of the multilayer film of the invention is by definition the polymer layer situated on the outside of the packaging during processing of the film into a packaging, which is preferably a bag. This means that when the film is further processed into packagings, it is in direct contact with the surface of the welding tool and therefore requires preferably a high melting/softening temperature that is preferably above 125° C., particularly preferably between 127° C. and 150° C., very particularly preferably between 130° C. and 145° C. For this reason, the first polymer layer (A) preferably comprises at least one aliphatic polyolefin homopolymer, particularly preferably at least one polypropylene homopolymer that, to improve the impact strength, particularly at low temperatures, is optionally modified with 0% to 30% by weight, preferably with 2% to 20% by weight, particularly preferably 3% to 10% by weight, in particular 5% to 10% by weight, of at least one impact modifier. The first polymer layer (A) very particularly preferably consists of a polypropylene homopolymer modified with an impact modifier selected from the group of styrene block copolymers, such as for example styrene-ethylene/butylene block copolymers, and/or from the group of copolymers of ethylene with at least one aliphatic olefin containing more than 3 carbon atoms, such as for example ethylene-butylene copolymers. The first polymer layer (A) particularly preferably consists of 90% to 97% by weight of polypropylene homopolymer and 3% to 10% by weight of styrene block copolymers and/or copolymers of ethylene with at least one aliphatic olefin containing more than 3, preferably 4 to 8, carbon atoms. In a preferred embodiment, the first polymer layer (A) consists of 97% by weight of a polypropylene homopolymer and 3% by weight of a styrene-ethylene/butylene block copolymer. The weight data for the components of the first polymer layer (A) refer to the total weight of the first polymer layer (A).

The second polymer layer (B) is by definition the polymer layer situated on the inside of the packaging during processing of the multilayer film of the invention into a packaging, which is preferably a bag. This polymer layer is responsible for ensuring that the packaging can be sealed tightly by welding. The second polymer layer (B) of the film must be weldable to itself and to appropriately inserted port elements reliably and at the lowest possible temperature and shortest possible welding time and still be heat-sterilizable at temperatures of more than 121° C. A low welding temperature is particularly important in order to put as little stress as possible on the film structure. The melting/softening temperature of the second polymer layer (B) is accordingly preferably above 121° C., particularly preferably between 122° C. and 135° C., particularly preferably between 124° C. and 130° C., but in any case below the melting/softening temperature of the first polymer layer (A). For this reason, the second polymer layer (B) of the multilayer film of the invention preferably comprises at least one aliphatic polyolefin copolymer, particularly preferably at least one polyolefin terpolymer and/or polyolefin bipolymer, very particularly preferably at least one polypropylene terpolymer and/or polypropylene bipolymer that, to improve the impact strength, particularly at low temperatures, is optionally modified with 5% to 50% by weight, preferably 10% to 40% by weight, particularly preferably with 15% to 30% by weight, very particularly preferably 17% to 25% by weight, of at least one impact modifier. The second polymer layer (B) preferably consists of a polypropylene terpolymer and/or a polypropylene bipolymer, which is modified with an impact modifier selected from styrene block copolymers and/or copolymers of ethylene with at least one aliphatic olefin containing more than 3, preferably 4 to 8, carbon atoms. The second polymer layer (B) particularly preferably consists of 75% to 83% by weight of polypropylene terpolymer and 17% to 25% by weight of styrene block copolymers and/or copolymers of ethylene with at least one aliphatic olefin containing more than 3, preferably 4 to 8, carbon atoms. In a preferred embodiment, the second polymer layer (B) consists of 85% by weight of a polypropylene-ethylene-butylene terpolymer and 15% by weight of a styrene-ethylene/butylene block copolymer. In another preferred embodiment, the second polymer layer (B) consists of 75% by weight of a polypropylene-ethylene-butylene terpolymer, 20% by weight of a styrene-ethylene/butylene block copolymer and 5% by weight of an ethylene-octylene copolymer. The weight data for the components of the second polymer layer (B) refer to the total weight of the second polymer layer (B).

The central polymer layer (C) has the largest mass fraction (at least 50% by weight) of the multilayer film, preferably 60% to 95% by weight, particularly preferably 70% to 90% by weight, very particularly preferably 75% to 85% by weight, of the entire multilayer film and serves to improve the impact strength of the structure as a whole, and also to provide protection against UV radiation and visible light. It preferably comprises at least one aliphatic polyolefin terpolymer, particularly preferably at least one polypropylene terpolymer in a proportion from 15% to 80% by weight, particularly preferably 20% to 75% by weight, very particularly preferably 25% to 60% by weight, that, to improve the impact strength, particularly at low temperatures, is optionally modified with 0% to 60% by weight, preferably 5% to 55% by weight, particularly preferably 20% to 50% by weight at least one impact modifier. The impact modifier is preferably selected from styrene block copolymers and/or copolymers of ethylene with at least one aliphatic olefin containing more than 3, preferably 4 to 8, carbon atoms and preferably comprises a styrene-ethylene/butylene block copolymer. The weight data for the components of the central polymer layer (C) refer to the total weight of the central polymer layer (C).

The central polymer layer (C) of the multilayer film of the invention comprises at least one, preferably 1 to 4, particularly preferably 1 or 2, very particularly preferably one, UV absorber and at least one, preferably 1 to 4, particularly preferably 1 or 2, very particularly preferably preferably one, colorant selected from organic pigments, inorganic pigments, organic dyes, and inorganic dyes, which in combination ensure the requisite protection for light-sensitive medicaments against UV and light in the 175 nm to 525 nm wavelength range. The amount of UV absorber present in the central polymer layer (C) is preferably between 0.01% and 10% by weight, particularly preferably between 0.1% and 8% by weight, very particularly preferably between 1% and 7% by weight, based on the total weight of the central polymer layer (C). The amount of colorant is preferably between 0.01% and 10% by weight, particularly preferably between 0.1% and 8% by weight, very particularly preferably between 1% and 7% by weight, based on the total weight of the central polymer layer (C).

In a preferred embodiment, polymer layers (A) and (B) comprise the preferred amounts of the individual components.

In another preferred embodiment, polymer layers (A) and (C) comprise the preferred amounts of the individual components.

In another preferred embodiment, polymer layers (B) and (C) comprise the preferred amounts of the individual components.

In another preferred embodiment, polymer layers (A), (B), and (C) comprise the preferred amounts of the individual components.

In another preferred embodiment, the first polymer layer (A) comprises at least one polyolefin homopolymer modified with an impact modifier to improve the impact strength, and the second polymer layer (B) comprises at least one aliphatic polyolefin copolymer modified with an impact modifier to improve the impact strength.

In another preferred embodiment, the first polymer layer (A) comprises at least one polyolefin homopolymer modified with an impact modifier to improve the impact strength, and the central polymer layer (C) comprises at least one aliphatic polyolefin terpolymer modified with an impact modifier to improve the impact strength.

In another preferred embodiment, the second polymer layer (B) comprises at least one aliphatic polyolefin copolymer modified with an impact modifier to improve the impact strength, and the central polymer layer (C) comprises at least one aliphatic polyolefin terpolymer modified with an impact modifier to improve the impact strength.

In another preferred embodiment, the first polymer layer (A) comprises at least one aliphatic polyolefin homopolymer modified with an impact modifier to improve the impact strength, the second polymer layer (B) comprises at least one aliphatic polyolefin copolymer modified with an impact modifier to improve the impact strength, and the central polymer layer (C) comprises at least one aliphatic polyolefin terpolymer modified with an impact modifier to improve the impact strength.

In a particularly preferred embodiment, polymer layers (A) and (B) comprise the particularly preferred amounts of the individual components.

In another particularly preferred embodiment, polymer layers (A) and (C) comprise the particularly preferred amounts of the individual components.

In another particularly preferred embodiment, polymer layers (B) and (C) comprise the particularly preferred amounts of the individual components.

In another particularly preferred embodiment, polymer layers (A), (B), and (C) comprise the particularly preferred amounts of the individual components.

In another particularly preferred embodiment, the first polymer layer (A) comprises at least one polypropylene homopolymer that, to improve the impact strength, is modified with a styrene block copolymer and/or copolymer of ethylene with at least one aliphatic olefin containing more than 3 carbon atoms, and the second polymer layer (B) comprises at least one aliphatic polyolefin bipolymer or one aliphatic polyolefin terpolymer that, to improve the impact strength, is modified with a styrene block copolymer and/or copolymer of ethylene with at least one aliphatic olefin containing more than 3 carbon atoms.

In another particularly preferred embodiment, the first polymer layer (A) comprises at least one polypropylene homopolymer that, to improve the impact strength, is modified with a styrene block copolymer and/or copolymer of ethylene with at least one aliphatic olefin containing more than 3 carbon atoms, and the central polymer layer (C) comprises at least one aliphatic polypropylene terpolymer that, to improve the impact strength, is modified with a styrene block copolymer and/or copolymer of ethylene with at least one aliphatic olefin containing more than 3 carbon atoms.

In another particularly preferred embodiment, the second polymer layer (B) comprises at least one aliphatic polyolefin bipolymer or one aliphatic polyolefin terpolymer that, to improve the impact strength, is modified with a styrene block copolymer and/or copolymer of ethylene with at least one aliphatic olefin containing more than 3 carbon atoms, and the central polymer layer (C) comprises at least one aliphatic polypropylene terpolymer that, to improve the impact strength, is modified with a styrene block copolymer and/or copolymer of ethylene with at least one aliphatic olefin containing more than 3 carbon atoms.

In another particularly preferred embodiment, the first polymer layer (A) comprises at least one polypropylene homopolymer that, to improve the impact strength, is modified with a styrene block copolymer and/or copolymer of ethylene with at least one aliphatic olefin containing more than 3 carbon atoms, the second polymer layer (B) comprises at least one aliphatic polyolefin bipolymer or one aliphatic polyolefin terpolymer that, to improve the impact strength, is modified with a styrene block copolymer and/or copolymer of ethylene with at least one aliphatic olefin containing more than 3 carbon atoms, and the central polymer layer (C) comprises at least one aliphatic polypropylene terpolymer that, to improve the impact strength, is modified with a styrene block copolymer and/or copolymer of ethylene with at least one aliphatic olefin containing more than 3 carbon atoms.

In a very particularly preferred embodiment, polymer layers (A) and (B) comprise the very particularly preferred amounts of the individual components.

In another very particularly preferred embodiment, polymer layers (A) and (C) comprise the very particularly preferred amounts of the individual components.

In another very particularly preferred embodiment, polymer layers (B) and (C) comprise the very particularly preferred amounts of the individual components.

In another very particularly preferred embodiment, polymer layers (A), (B), and (C) comprise the very particularly preferred amounts of the individual components.

In another very particularly preferred embodiment, the first polymer layer (A) comprises a polypropylene homopolymer that, to improve the impact strength, is modified with a styrene-ethylene/butylene block copolymer and/or copolymer of ethylene with at least one aliphatic olefin containing 4 to 8 carbon atoms, and the second polymer layer (B) comprises an aliphatic polypropylene bipolymer or an aliphatic polypropylene terpolymer, preferably a polypropylene-ethylene-butylene terpolymer, that, to improve the impact strength, is modified with a styrene-ethylene/butylene block copolymer and/or copolymer of ethylene with at least one aliphatic olefin containing 4 to 8 carbon atoms.

In another very particularly preferred embodiment, the first polymer layer (A) comprises a polypropylene homopolymer that, to improve the impact strength, is modified with a styrene-ethylene/butylene block copolymer and/or copolymer of ethylene with at least one aliphatic olefin containing 4 to 8 carbon atoms, and the central polymer layer (C) comprises a polypropylene-ethylene-butylene terpolymer that, to improve the impact strength, is modified with a styrene-ethylene/butylene block copolymer and/or copolymer of ethylene with at least one aliphatic olefin containing 4 to 8 carbon atoms.

In another very particularly preferred embodiment, the second polymer layer (B) comprises an aliphatic polypropylene bipolymer or an aliphatic polypropylene terpolymer, preferably a polypropylene-ethylene-butylene terpolymer, that, to improve the impact strength, is modified with a styrene-ethylene/butylene block copolymer and/or copolymer of ethylene with at least one aliphatic olefin containing 4 to 8 carbon atoms, and the central polymer layer (C) comprises a polypropylene-ethylene-butylene terpolymer that, to improve the impact strength, is modified with a styrene-ethylene/butylene block copolymer and/or copolymer of ethylene with at least one aliphatic olefin containing 4 to 8 carbon atoms.

In another very particularly preferred embodiment, the first polymer layer (A) comprises a polypropylene homopolymer that, to improve the impact strength, is modified with a styrene-ethylene/butylene block copolymer and/or copolymer of ethylene with at least one aliphatic olefin containing 4 to 8 carbon atoms, the second polymer layer (B) comprises an aliphatic polyolefin bipolymer or an aliphatic polypropylene terpolymer, preferably a polypropylene-ethylene-butylene terpolymer, that, to improve the impact strength, is modified with a styrene-ethylene/butylene block copolymer and/or copolymer of ethylene with at least one aliphatic olefin containing 4 to 8 carbon atoms, and the central polymer layer (C) comprises a polypropylene-ethylene-butylene terpolymer that, to improve the impact strength, is modified with a styrene-ethylene/butylene block copolymer and/or copolymer of ethylene with at least one aliphatic olefin containing 4 to 8 carbon atoms.

The at least one UV absorber is preferably selected from the group consisting of
a) organic UV absorbers, in particular benzophenones, benzotriazoles, oxalanilides, and/or phenyltriazines,
b) inorganic UV absorbers, in particular titanium dioxide, iron oxide pigments, silicon dioxide, and/or zinc oxide,
c) polymeric UV absorbers, in particular PMMA microspheres (polymethyl methacrylate), and
d) HALS (hindered amine light stabilizers) UV absorbers, in particular 2,2,6,6-tetramethylpiperidine derivatives, or
e) a combination thereof.

The at least one colorant is preferably selected from organic and inorganic pigments, particularly preferably from inorganic pigments, the inorganic pigments preferably being selected from iron oxides, zinc ferrite color pigments, iron-oxide-coated mica, and mixed-phase oxide pigments. Among mixed-phase oxide pigments, particular preference is given to chromium antimony titanate and/or nickel antimony titanate. The colorants mentioned and combinations thereof ensure the requisite protection from light in the visual range of the light spectrum up to 525 nm.

In a preferred embodiment, the central polymer layer (C) comprises at least one organic UV absorber and at least one inorganic pigment.

In another preferred embodiment, the central polymer layer (C) comprises at least one inorganic UV absorber and at least one inorganic pigment.

In another preferred embodiment, the central polymer layer (C) comprises at least one polymeric UV absorber and at least one inorganic pigment.

In another preferred embodiment, the central polymer layer (C) comprises at least one HALS UV absorber and at least one inorganic pigment.

In a particularly preferred embodiment, the central polymer layer (C) comprises benzophenone, benzotriazole, oxalanilide, and/or phenyltriazine, and also at least one iron oxide, zinc ferrite color pigment, iron-oxide-coated mica, and/or mixed-phase oxide pigment.

In another particularly preferred embodiment, the central polymer layer (C) comprises titanium dioxide, iron oxide pigment, silicon dioxide, and/or zinc oxide, and also at least one zinc ferrite color pigment, iron-oxide-coated mica, and/or mixed-phase oxide pigment.

In another particularly preferred embodiment, the central polymer layer (C) comprises PMMA microspheres and also at least one iron oxide, zinc ferrite color pigment, iron-oxide-coated mica, and/or mixed-phase oxide pigment.

In another particularly preferred embodiment, the central polymer layer (C) comprises at least one 2,2,6,6-tetramethylpiperidine derivative and also at least one iron oxide, zinc ferrite color pigment, iron-oxide-coated mica, and/or mixed-phase oxide pigment.

In a very particularly preferred embodiment, the central polymer layer (C) consists of 68% by weight of a polypropylene-ethylene-butylene terpolymer, 20% by weight of a styrene-ethylene/butylene block copolymer, 5% by weight of a polyethylene elastomer, for example from the Engage series from Dow, 4% by weight of a HALS UV absorber, and 3% by weight of a yellow iron(III) oxide pigment. In another particularly preferred embodiment, the central polymer layer (C) consists of 67% by weight of a polypropylene-ethylene-butylene terpolymer, 20% by weight of a styrene-ethylene/butylene block copolymer, 5% by weight of a polyethylene elastomer, for example from the Engage series from Dow, 4% by weight of a PMMA UV absorber, and 4% by weight of a red iron(III) oxide pigment.

In one embodiment, the first polymer layer (A) is an outer polymer layer of the multilayer film of the invention. In another embodiment, the second polymer layer (B) is an outer polymer layer of the multilayer film of the invention. In a preferred embodiment, the first polymer layer (A) and the second polymer layer (B) are outer polymer layers of the multilayer film of the invention.

UV absorbers and colorants are preferably present only in polymer layer (C), i.e. polymer layers (A) and (B), particularly preferably the entire further multilayer film, do not contain any UV absorber or any colorant. Very particularly preferably, the entire multilayer film of the invention consists only of polymer layers (A), (B), and (C).

Another advantage of the multilayer film of the invention is that the central polymer layer (C) is covered on the two sides by respectively a first polymer layer (A) and a second polymer layer (B), i.e. there is no direct contact with the central polymer layer (C) and thus of the additives with the infusion solution.

Since the at least one UV absorber and the at least one colorant are present in the central polymer layer (C), complete coloration of the film does not occur, i.e. the film remains translucent, which means it is still possible to visually check the infusion solution before it is administered. The preferred use of pigments as colorants also has the advantage that they do not migrate and thus it is not possible for the infusion solution to be contaminated by the pigments.

It is preferable that none of polymer layers (A), (B), and (C) is coated or laminated with a further material comprising further additives, in particular UV absorber and/or aluminum.

Polymer layers (A), (B), and (C) preferably adhere to one another without using an adhesion promoter, i.e. the multilayer film of the invention preferably does not contain an adhesion promoter. Moreover, it is preferable that at least the second polymer layer (B) does not contain any further chemical additives, modifiers or plasticizers, such as for example mineral oil; very particularly preferably, none of polymer layers (A), (B), and (C) comprise further chemical additives, modifiers or plasticizers. Accordingly, the medical solution is affected to the smallest possible degree by the multilayer film of the invention as packaging material during sterilization and storage.

The physical properties of the first polymer layer (A) in respect of impact strength may be significantly poorer than those of the second polymer layer (B), particularly at low temperatures, consequently a layer thickness of the first polymer layer (A) that is too high can adversely affect the properties of the multilayer film of the invention. For this reason, the layer thickness of the first polymer layer (A) is preferably 0.5% to 15%, particularly preferably 1% to 13%, very particularly preferably 3% to 11%, of the total thickness of the film. The layer thickness of the second polymer layer (B) is preferably 2% to 30%, particularly preferably 4% to 25%, very particularly preferably 6% to 20%, of the total thickness of the film. The central polymer layer (C) has the largest proportion (at least 50% of the total thickness of the film) of the multilayer film and serves to improve the impact strength of the structure as a whole. The layer thickness of the central polymer layer (C) accordingly accounts for preferably 55% to 97.5%, preferably 62% to 95%, very particularly preferably 69% to 91%, of the total thickness of the film. The total thickness of the film is preferably 50 to 500 μm, particularly preferably 100 to 400 μm, very particularly preferably 150 to 300 μm.

An important criterion for the use of the multilayer film of the invention as primary packaging material for medical solutions is the barrier effect against liquid loss. Such loss of liquid results in concentration of the active ingredients in the solution, which must not exceed certain values. The loss of liquid during storage determines inter alia the shelf life of the product. The formulation of the multilayer film of the invention is advantageously chosen so as to achieve, alongside good impact strength, a very good barrier to water vapor. This can be achieved in particular by using the above-listed materials of polymer layers (A), (B), and (C) in the production of the multilayer film.

The multilayer film of the invention is by preference produced by coextrusion and preferably shock-cooled with water. The coextrusion can preferably be effected in such a way that the multilayer film of the invention is extruded in the form of a flat film or a tubular film, wherein, in the case of a tubular film, the outside consists of the first polymer layer (A) and the inside of the second polymer layer (B).

The multilayer film of the invention can be processed further, for example to produce medical packagings, preferably medical bags.

The medical packaging of the invention is suitable in particular as a container for at least one medicament, the medical packaging having particularly advantageous suitability as a container for medicaments sensitive to UV and light by virtue of the protection ensured against UV and light. In a preferred embodiment, the packaging of the invention is subdivided into chambers that allow it to be used as a container for a plurality of medicaments at the same time. This is relevant, for example, for those combinations of medicaments that have to be administered together, but are not stable in combination over long periods of time, or for solid medicaments that are administered in the form of a solution or suspension, but not are not stable in the solution or suspension for long periods of time. The constituents of the final dosage form can be stored separately by means of separate chambers and mixed with one another shortly before administration by opening the separation points.

A process for producing the medical packaging of the invention, preferably a bag, comprises the steps of:
a) providing at least one heat-sterilizable multilayer film of the invention;
b) optionally providing one or more port elements and/or tubing units;
c) forming a medical packaging, preferably a bag, from the at least one heat-sterilizable multilayer film, such that the second polymer layer (B) forms the inner surface of the medical packaging, preferably of the bag, and the first polymer layer (A) forms the outer surface of the medical packaging, preferably of the bag;
d) optionally positioning the port elements and/or tubing units between the inner surfaces at the edges of the medical packaging, preferably of the bag;
e) bringing the inner surfaces at the edges of the medical packaging, preferably of the bag, into contact with one another and with port elements and/or tubing units optionally positioned therebetween;
f) welding the inner surfaces at the edges of the medical packaging, preferably of the bag, to one another and to port elements and/or tubing units optionally positioned therebetween.

In step a) the multilayer film of the invention is preferably provided in the form of a flat film or a tubular film. Depending on the provided form of the film, the further process may differ in certain details.

Depending on the use of the medical packaging of the invention, preferably of the bag, additional elements, such as for example port elements and/or tubing units, may in the process optionally be provided in step b) after providing the multilayer film of the invention. The provision of these elements is useful for example when the medical packaging of the invention, preferably the bag, is to be used as a fixed component of a medical device or is to be connected to a medical device. Omitting step b) can be useful for example when the medical packaging, preferably the bag, is used solely for storage of a medicament and is damaged to withdraw the medicament, for example by tearing open or piercing with a cannula.

In step c), the provided multilayer film of the invention is brought into the form of a medical packaging, preferably a bag. When a tubular film has been provided in step a), the forming of the medical packaging, preferably of the bag, may for example include only the cutting of the tubular film to the desired length, since the second polymer layer (B) already forms the inner surface of the tubular film and the first polymer layer (A) the outer surface of the tubular film. When a flat film has been provided in step a), it is possible in step c) for the medical packaging, preferably the bag, to for example be formed from a piece of multilayer film by cutting this piece into a mirror-symmetrical shape and folding it over along the mirror axis so that the edges of the film lie congruently on top of one another, with the second polymer layer (B) on the inside. Alternatively, it is possible for the medical packaging of the invention, preferably the bag, to for example be formed from two pieces of flat film by cutting the two pieces mirror-symmetrically to one another and placing them congruently on top of one another, with the second polymer layer (B) on the inside. Rectangular shapes are particularly preferred for cutting, since this results in the least material loss and the simplest processability. However, other shapes are also possible, for example it is possible to produce a medical packaging, preferably a bag, having an aesthetic shape that is appealing to children and distracts them from the actual administration of a medicament.

Depending on whether additional elements such as port elements and/or tubing units have been provided in step b), these elements can in step d) be positioned between the inner surfaces at the edges of the formed medical packaging, preferably of the bag. In the case of a tubular film, this means the insertion of the additional elements into the openings of the tubular film. In this case, it is possible for the elements to be positioned only on two opposite sides of the medical packaging, preferably of the bag. In the case of a flat film, this means the insertion of the additional elements between the edges of the one or more flat film pieces laid congruently on top of one another in step c). The elements may be positioned at any point along the edges, preferably on two opposite edges at most.

In step e), the inner surfaces of the formed medical packaging, preferably of the bag, are brought into contact with one another at the edges thereof and with the additional elements optionally located between the inner surfaces, in order that they may in step f) be welded together by supplying heat and optionally mechanical pressure. The chosen temperature for welding is preferably above the melting/softening point of the second polymer layer (B), but below the melting/softening point of the first polymer layer (A). This makes it possible to ensure that the second polymer layer (B) melts at the edges of the medical packaging, preferably of the bag, thereby closing it firmly and fluid-tight, whereas the first polymer layer (A) retains its shape, thereby maintaining the stability of the medical packaging, preferably of the bag.

### DEFINITIONS

The term “heat-sterilizable” means that corresponding materials can be subjected to sterilization at elevated temperatures, preferably to steam sterilization. Sterilization is the term used to describe the process by which materials and objects are freed from living microorganisms. The state that the materials and objects attain in this way is termed “sterile”. In the steam sterilization of the filled or unfilled medical packagings, hot water vapor is used for the sterilization, which is typically carried out in an autoclave. The medical packagings are preferably heated in water vapor for 20 minutes at 121° C. and 2 bar pressure. The air inside the autoclave is here completely replaced by water vapor.

The term “aliphatic polyolefin” refers to a polyolefin that consists essentially of carbon atoms and hydrogen atoms, i.e. has no heteroatoms in the repeat units incorporated through polymerization and does not contain any aromatic groups. In addition to homopolymers, the term also encompasses copolymers, i.e. polymers comprising at least two different monomer units, for example bipolymers or terpolymers.

The term “multilayer film” refers to thermoplastic materials in a plurality of coextruded polymer layers bonded to one another to form a film in the form of a running web or a tubing unit.

The term “homopolymer” refers to a polymer produced from a monomer.

The term “copolymer” refers to a polymer produced from at least two different monomers.

The term “bipolymer” denotes a copolymer produced from two different monomers.

The term “terpolymer” denotes a copolymer produced from three different monomers.

The term “polypropylene terpolymer” refers to a polypropylene molecular chain modified with two additional co-monomers in the polymerization process. Preferred additional co-monomers are ethylene and/or C₄-C₁₆ α-olefins, particularly preferably ethylene and/or C₄-C₈ α-olefins, very particularly preferably ethylene and butylene.

The term “polypropylene bipolymer” refers to a polypropylene molecular chain modified with an additional co-monomer in the polymerization process. Preferred co-monomers are ethylene or C₄-C₁₆ α-olefins, particularly preferably ethylene or C₄-C₈ α-olefins, very particularly preferably ethylene or butylene, preferably ethylene.

The term “polypropylene homopolymer” refers to polymers that exclusively comprise propylene as a monomer.

The term “polyethylene copolymer” refers to ethylene/α-olefin copolymers that in the polymerization of ethylene are generally modified by one or more α-olefins, and are also referred to as polyethylene elastomers. Ethylene/α-olefin copolymers generally have a density range of 0.86 to 0.44 g/cm³. Preferred α-olefins are C₃-C₁₆ α-olefins, particularly preferably C₃-C₁₂ α-olefins, very particularly preferably C₄-C₈ α-olefins, for example 1-butene, 1-hexene or 1-octene. The term “styrene block copolymers” refers to synthetic thermoplastic elastomers, such as for example styrene-ethylene/butylene block copolymers and styrene-ethylene/propylene block copolymers, which are commonly used for impact modification of polypropylene.

The term “polyolefin” refers to olefin polymers in the form of homopolymers of olefins and copolymers of olefins, in particular bi- and terpolymers of olefins and modified polymers of the above.

The term “impact strength” refers to the property of a material to withstand a dynamic load. The Izod impact strength of plastics can be measured under defined conditions in accordance with standard DIN EN ISO 180:2013-08.

The term “pigment” refers to inorganic or organic, colored or achromatic colorants, i.e. color-imparting substances that, in contrast to colorants, are practically insoluble in the application medium. The application medium is the substance into which the pigment is incorporated, such as for example oils or plastics.

The term “UV absorber” refers to chemical compounds added to various materials, such as for example polymers, as protection against aging caused by UV radiation. UV absorbers work according to the principle of light absorption. The invention differentiates between organic, inorganic, polymeric UV absorbers and also HALS (hindered amine light stabilizers) absorbers.

The term “impact modifier” refers to polymeric materials, such as for example styrene block copolymers and polyethylene elastomers, that, through incorporation in the molten state, improve the impact strength of the polymer surrounding the impact modifier.

The invention is elucidated in more detail hereinbelow with reference to examples, without being limiting thereto.

### EXAMPLE 1

First Polymer Layer (A):
97% by weight of PP 41 E4 cs278 from Huntsman Corp., USA, polypropylene homopolymer
3% by weight of Tuftec H1062 from Asahi, Japan, styrene-ethylene/butylene block copolymer

The above formulation was mixed in the molten state in a separate compounding step and granulated for further use.

Second Polymer Layer (B):
85% by weight of TD 120 BF, Borealis, Austria, terpolymer
15% by weight of Tuftec H1062 from Asahi, Japan, styrene-ethylene/butylene block copolymer

The above formulation was mixed in the molten state in a separate compounding step and granulated for further use.

Central Polymer Layer (C):
68% by weight of TD 120 BF, Borealis, Austria, terpolymer
20% by weight of Tuftec H1062 from Asahi, Japan, styrene-ethylene/butylene block copolymer
5% by weight of Engage 8003, Dow, USA, polyethylene elastomer
4% by weight of Luvobatch PP UV5082, Lehmann & Voss, Germany, UV absorber
3% by weight of yellow iron(III) oxide, product 2233, Caesar & Loretz GmbH, Germany, colorant

The above formulation was mixed in the molten state in a separate compounding step and granulated for further use.

The film was coextruded on a blown-film line with water cooling using process parameters customary for polypropylene.

The film was produced with a total thickness of 200 μm, the first polymer layer (A) and second polymer layer (B) each having a thickness of 15 μm and the central polymer layer (C) having a thickness of 170 μm. The film produced can be sterilized with hot steam and is already capable of being firmly welded with welding tools heated to a temperature of 125° C.

### EXAMPLE 2

First Polymer Layer (A):
97% by weight of PP 41 E4 cs278 from Huntsman Corp., USA, polypropylene homopolymer
3% by weight of Tuftec H1062 from Asahi, Japan, styrene-ethylene/butylene block copolymer

The above formulation was mixed in the molten state in a separate compounding step and granulated for further use.

Second Polymer Layer (B):
75% by weight of TD 120 BF, Borealis, Austria, terpolymer
20% by weight of Tuftec H1062 from Asahi, Japan, styrene-ethylene/butylene block copolymer
5% by weight of Engage 8003, Dow, USA, polyethylene elastomer

The above formulation was mixed in the molten state in a separate compounding step and granulated for further use.

Central Polymer Layer (C):
67% by weight of TD 120 BF, Borealis, Austria, terpolymer
20% by weight of Tuftec H1062 from Asahi, Japan, styrene-ethylene/butylene block copolymer
5% by weight of Engage 8003, Dow, USA, polyethylene elastomer
4% by weight of CopoBeads PMMA microspheres (5 μm diameter), Coating Products OHZ eK, Germany, polymeric UV absorber
4% by weight of red iron(III) oxide, product 2337, Caesar & Loretz GmbH, Germany, colorant

The above formulation was mixed in the molten state in a separate compounding step and granulated for further use.

The film was coextruded on a blown-film line with water cooling using process parameters customary for polypropylene.

The film was produced with a total thickness of 200 μm, the first polymer layer (A) and second polymer layer (B) each having a thickness of 15 μm and the central polymer layer (C) having a thickness of 170 μm. The film produced can be sterilized with hot steam and is already capable of being firmly welded with welding tools heated to a temperature of 125° C.

1. A heat-sterilizable multilayer film comprising:
a) a first polymer layer (A),
b) a second polymer layer (B), and
c) a central polymer layer (C),
wherein the central polymer layer (C) is situated between the first polymer layer (A) and the second polymer layer (B),
wherein each of the three polymer layers (A), (B), and (C) comprises at least one aliphatic polyolefin,
wherein the central polymer layer (C) comprises at least one UV absorber and at least one colorant from inorganic pigments selected from the group consisting of:
a) iron oxides,
b) zinc ferrite color pigments,
c) iron-oxide-coated mica, and
d) mixed-phase oxide pigments, wherein the combination of at least one UV absorber and at least one colorant absorbs radiation in the 175 nm to 525 nm wavelength range, and
wherein:
the first polymer layer (A) comprises at least one polypropylene homopolymer modified with at least one impact modifier,
the second polymer layer (B) comprises at least one polypropylene terpolymer and/or polypropylene bipolymer modified with at least one impact modifier,
the central polymer layer (C) comprises at least one polypropylene terpolymer modified with at least one impact modifier, and
the central polymer layer has a mass fraction of 70% to 90% by weight of the total multilayer film.

2. The heat-sterilizable multilayer film of claim 1, wherein the central polymer layer (C) comprises at least one UV absorber selected from the group consisting of:
a) organic UV absorbers,
b) inorganic UV absorbers,
c) polymeric UV absorbers,
d) HALS (hindered amine light stabilizers) UV absorbers, and
e) combination of two or more UV absorbers from groups a) to d).

3. The heat-sterilizable multilayer film of claim 1, wherein the at least one impact modifier is selected from the group consisting of styrene block copolymers, polyethylene copolymers, and polyethylene elastomers.

4. The heat-sterilizable multilayer film of claim 1, wherein the total thickness of the multilayer film is between 50 μm and 500 μm.

5. The heat-sterilizable multilayer film of claim 1, wherein the multilayer film is a flat or tubular film.

6. The heat-sterilizable multilayer film of claim 1, wherein at least the second polymer layer (B), is free from chemical modifiers, plasticizers, and adhesion promoters.

7. The heat-sterilizable multilayer film of claim 1, consisting of polymer layers (A), (B), and (C).

8. A process for producing a heat-sterilizable multilayer film of claim 1, comprising a step in which the first polymer layer (A), the central polymer layer (C), and the second polymer layer (B) are coextruded.

9. (canceled)

10. A medical packaging comprising a heat-sterilizable multilayer film of claim 1.

11. A container for at least one medicament comprising the medical packaging of claim 10.

12. A process for producing a medical packaging comprising the steps of:
a) providing at least one heat-sterilizable multilayer film of claim 1;
b) optionally providing one or more port elements and/or tubing units;
c) forming a medical packaging from the at least one heat-sterilizable multilayer film, such that the second polymer layer (B) forms the inner surface of the medical packaging and the first polymer layer (A) forms the outer surface of the medical packaging;
d) optionally positioning the port elements and/or tubing units between the inner surfaces at the edges of the medical packaging;
e) bringing the inner surfaces at the edges of the medical packaging into contact with one another and with port elements and/or tubing units optionally positioned therebetween; and
f) welding the inner surfaces at the edges of the medical packaging to one another and to port elements and/or tubing units optionally positioned therebetween.

13. The heat-sterilizable multilayer film of claim 1, wherein the iron oxides a) are yellow or red iron(III) oxide.

14. The heat-sterilizable multilayer film of claim 1, wherein the mixed-phase oxide pigments are chromium antimony titanate and/or nickel antimony titanate.

15. The heat-sterilizable multilayer film of claim 2, wherein the organic UV absorbers are benzophenones, benzotriazoles, oxalanilides, and/or phenyltriazines.

16. The heat-sterilizable multilayer film of claim 2, wherein the inorganic UV absorbers are titanium dioxide, iron oxide pigments, silicon dioxide, and/or zinc oxide.

17. The heat-sterilizable multilayer film of claim 2, wherein the polymeric UV absorbers are PMMA microspheres (polymethyl methacrylate).

18. The heat-sterilizable multilayer film of claim 2, wherein the HALS UV absorbers are 2,2,6,6-tetramethylpiperidine derivatives.

19. The medical packaging of claim 10, wherein the medical packaging is a medical multi-chamber bag.

20. The medical packaging of claim 10, wherein the medical packaging is subdivided into chambers.

21. The container of claim 11, wherein the at least one medicament is sensitive to light in the 175 nm to 525 nm wavelength range.
